(19) United States
(12) Patent Application Publication
(10) Pub. No.: US 2011/0307825 A1
(43) Pub. Date: Dec. 15, 2011

(54) SYSTEM AND METHOD FOR CREATION OF ADVERTISING SPACE INDEPENDENT FROM WEB SITE DESIGN

(75) Inventors: David Gorodyansky, Mountain View, CA (US); Eugene Lapidous, Saratoga, CA (US); Sergei Timoshchuk, Los Altos, CA (US)

(73) Assignee: ANCHORFREE, INC., Mountain View, CA (US)

(21) Appl. No.: 13/156,244

(22) Filed: Jun. 8, 2011

Related U.S. Application Data
(60) Provisional application No. 61/352,771, filed on Jun. 8, 2010.

(51) Int. Cl. G06F 3/048

(52) U.S. Cl. 715/781

(57) ABSTRACT

In one implementation, user's browser loads the web site document containing reference to an advertisement and one or more site elements; browser issues request for an advertisement to the ad server and starts positioning one or more site elements; ad server responds with a script, containing computer instructions; first set of instructions is executed after the browser determines which site elements should be positioned inside the browser window, first instructions shifting positions of at least some of such elements by a shift vector, thereby creating en empty space near the site content, and second set of instruction is executed to display advertisement inside that space.

### CROSS-REFERENCE TO RELATED PATENT APPLICATIONS

The present application relies on and claims benefit of priority under 35 U.S.C. 119 from U.S. provisional patent application Ser. No. 61/352,771, filed on Jun. 8, 2010, which is incorporated by reference herein in its entirety.

### BACKGROUND OF THE INVENTION

1. Field of the Invention

This invention relates in general to internet advertising and, more particularly, to dynamically and selectively displaying additional advertisements without changing the site design, location bar information or user navigation.

2. Description of the Related Art

Majority of the web sites display online advertisements, which often generate most of site publisher's income. Web site designers usually allocate specific areas where such advertisements should be placed, for instance below the navigation menu or surrounded by site's content. FIG. 1 illustrates exemplary content 100 including advertisement 101, which is displayed to the user according to conventional methodology. This conventional approach to placing advertisements makes it difficult to dynamically change the location where the advertisements are displayed, or to show different number of advertisements to different users: each option requires creating separate version of the web site design.

One known way to display additional advertisements without changing the web site design is to put the full displayed content of that web site inside another site, often from a different domain. For instance, web site A may display its own advertisement at the top of the web browser window and display full content of the web site B below that advertisement. Designers of web site A may accomplish it by loading site B inside HTML FRAME or IFRAME element, which is usually referred as “framing” the site.

This “framing” technique is usually considered harmful to the framed site: browser location bar displays URL of the site A instead of the site B, confusing the user and decreasing site B's traffic counted by monitoring services; clicking inside the framed site often changes content inside the frame but keeps visible the wrapping site A and its advertisement, etc. Because of that, many sites include special software code to detect and break such framing.

Accordingly, there is a need to provide site publishers with a way to dynamically and selectively display additional advertisements without changing the site design, location bar information or user navigation features.

### SUMMARY OF THE INVENTION

The inventive methodology is directed to methods and systems that substantially obviate one or more of the above and other problems associated with conventional techniques for dynamically and selectively displaying additional advertisements without changing the site design, location bar information or user navigation.

In accordance with one aspect of the present invention, there is provided a computer-implemented method executed on a computer system comprising a central processing unit and a memory. The method involves: a user browser loading a web site document containing a reference to an advertisement and one or more site elements, the browser displaying a browser window; the user browser issuing a request for an advertisement to an advertisement server and starting positioning one or more site elements within the browser window; and the user browser receiving from the advertisement server in response to the issued request a script, the script containing a first and a second sets of computer instructions; the first set of computer instructions being executed after the user browser determines which site elements should be positioned inside the browser window, first set of instructions shifting positions of at least some of the site elements by a shift vector, thereby creating an additional space near the site content, and the second set of computer instructions being executed to display an advertisement inside the additional space.

In accordance with another aspect of the present invention, there is provided a computer-readable medium comprising computer instructions, which, when executed by one or more processors of a computer system, cause the one or more processors to perform a computer-implemented method. The method involves: a user browser loading a web site document containing a reference to an advertisement and one or more site elements, the browser displaying a browser window; the user browser issuing a request for an advertisement to an advertisement server and starting positioning one or more site elements within the browser window; and the user browser receiving from the advertisement server in response to the issued request a script, the script containing a first and a second sets of computer instructions; the first set of computer instructions being executed after the user browser determines which site elements should be positioned inside the browser window, first set of instructions shifting positions of at least some of the site elements by a shift vector, thereby creating an additional space near the site content, and the second set of computer instructions being executed to display an advertisement inside the additional space.

In accordance with yet another aspect of the present invention, there is provided a computerized system incorporating: a memory unit; a central processing unit for executing a user browser for loading a web site document containing a reference to an advertisement and one or more site elements, the browser displaying a browser window, wherein the user browser issues a request for an advertisement to an advertisement server and starts positioning one or more site elements within the browser window; and a network interface for receiving from the advertisement server in response to the issued request a script, the script containing a first and a second sets of computer instructions; the first set of computer instructions being executed after the user browser determines which site elements should be positioned inside the browser window, first set of instructions shifting positions of at least some of the site elements by a shift vector, thereby creating an additional space near the site content, and the second set of computer instructions being executed to display an advertisement inside the additional space.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates content displayed to the user according to conventional methodology.

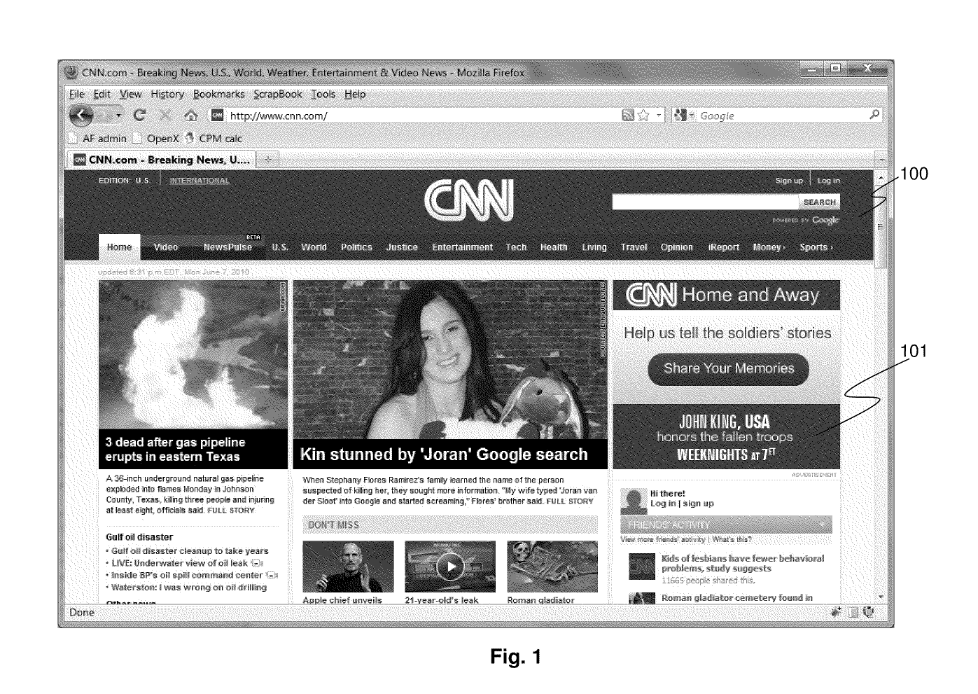

FIG. 2 illustrates content displayed to the user according to an embodiment of the inventive methodology.

FIG. 3 illustrates content displayed to the user according to an embodiment of the inventive methodology.

FIG. 4 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

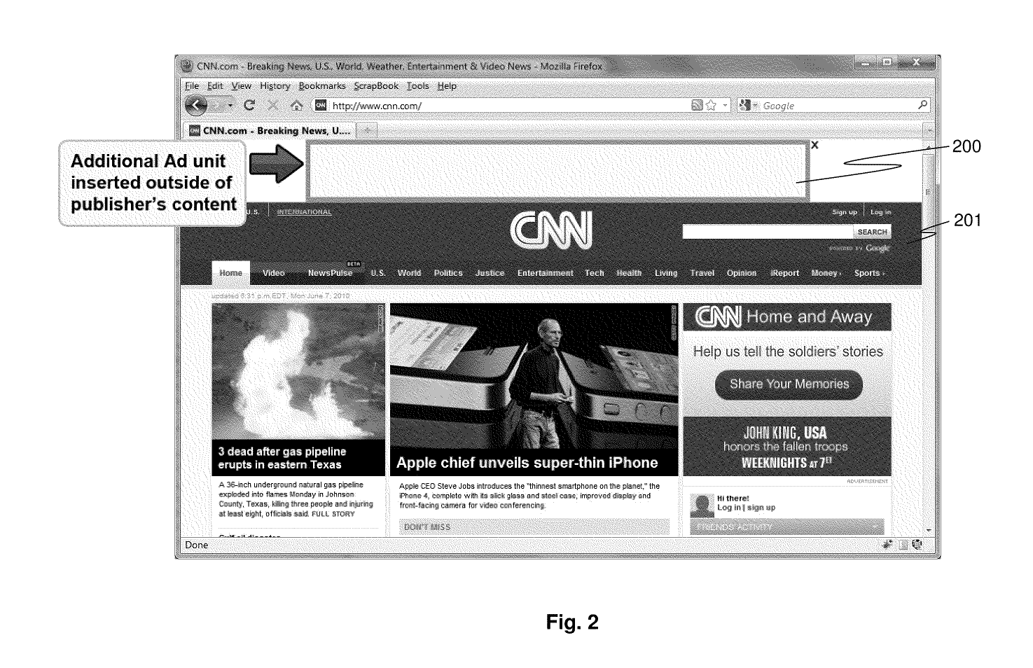

In accordance with an embodiment the inventive methodology, there is provided a system and method wherein user's browser loads the web site document containing reference to an advertisement and one or more site elements; browser issues a request for an advertisement to the advertisement information server (ad server) and starts positioning one or more site elements; the ad server responds with a script, containing computer instructions; first set of instructions is executed after the browser determines which site elements should be positioned inside the browser window, first instructions shifting positions of at least some of such elements by a shift vector, thereby creating an empty space 200 near the site content 201, as illustrated in FIG. 2, and a second set of instructions is executed to display the advertisement inside that space.

In one or more embodiments of the invention, first set instructions may be executed, for instance, after browser completes loading the document object model, detected when value of the document state becomes “ready” or “completed”.

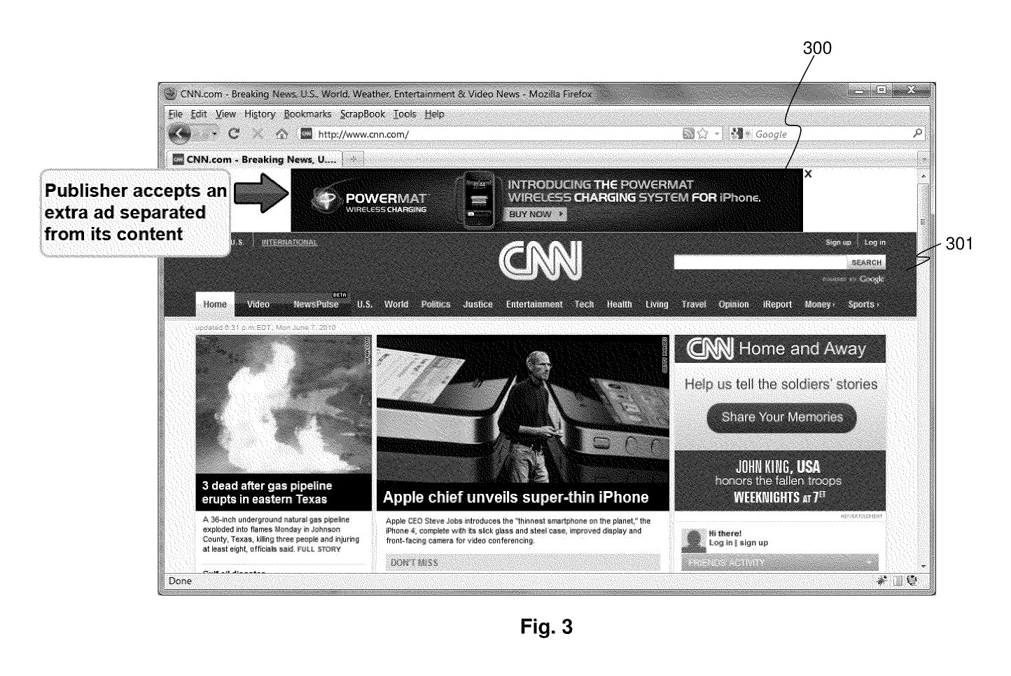

In one or more embodiments of the invention, first set of instructions may, for instance shift all site elements down by 90 pixels, while second set of instructions displays 90-pixel high advertisement 300 in the space above web site content 301, as illustrated in FIG. 3.

In one or more embodiments of the invention, first set of instructions may include enumerating site elements having “position: absolute” attribute and then adding the same shift vector to position of these elements.

In one or more embodiments of the invention, first set of instructions may include determining top elements in the chain of relatively positioned elements, and then adding the same shift vector to position of these elements.

In one or more embodiments of the invention, second set of instructions may include adding one or more elements to the document object model, at least one of these elements being positioned inside the empty space generated by shifting other visible elements of the site. Such added elements may include, for instance, IFRAME or DIV element used as a container to display an advertisement.

In one or more embodiments of the invention, these elements can be added after the first set of instructions is executed and empty space is created. Alternatively, these elements can be added before the first set of instructions is executed, but made visible only after the empty space is created. In the last case, first set of instructions applies position shift to original elements of the site, but not to the elements used to display additional advertisement.

In one or more embodiments of the invention, first set of instructions may shift all visible elements of the site by the same vector. Alternatively, first set of instructions may leave selected elements of the site in place, or shift them by another vector. For instance, first set of instructions may keep site navigation menu on top, but shift all elements below that menu. In each of these cases, present invention generates an additional space where an advertisement is displayed, instead of displaying an advertisement in a space allocated by the site document.

In one or more embodiments of the invention, first set of instructions includes detection whether all elements of the site can be successfully shifted to generate additional space. If such detection indicates that additional space may not be successfully created, site elements are not shifted or shifted back to original positions, and addition advertisement isn't displayed.

In one or more embodiments of the invention, for instance, additional space may be created only if user's browser is one of the allowed types (Firefox, Internet Explorer 7 or 8 but not 6).

In one or more embodiments of the invention, some sites may add elements after the document object model is completed, in response to user actions (for instance, drop-down from the menu) or to speed up initial site load (for instance, deferring execution of some scripts until the site load is complete).

In one or more embodiments of the invention, to correctly shift such lately-generated site elements, first set of instructions may include marking of already sifted elements, periodic checking of the document object for the new unmarked elements and either shifting these new elements or canceling display of the advertisement and removing additional space if new elements can't be successfully shifted.

In one or more embodiments of the invention, the elements displayed in an additionally created space may include interactive element allowing user to remove this additional space (“Close” button), hiding the additional advertisement. If user selects this element, the first set of instructions may reverse all previously applied shifts without reloading the site.

As would be appreciated by those of skill in the art, in one or more embodiments of the invention, main advantages of the aspects of the inventive technique include, without limitation:
displaying additional advertisement without changing the site design: the whole site is shifted by the same vector, as if placed inside the frame, but without limiting site navigation or changing information in the location bar, see FIGS. 2 and 3.
displaying additional advertisements in the same place for web sites with different designs. For instance, advertisement content may comprise a bar containing search input field and few social widgets, always displayed above the content of different sites.
giving site publishers control when to display additional advertisement: for instance, additional advertisement can be displayed only if number of daily site visits stays above the threshold, making sure that additional advertisements don't decrease popularity of the site, as illustrated in FIG. 3.
giving advertisers ability to display additional advertisements only to targeted groups of users: for instance, to users from selected countries, or to users who expressed interest in such advertisements in the past.

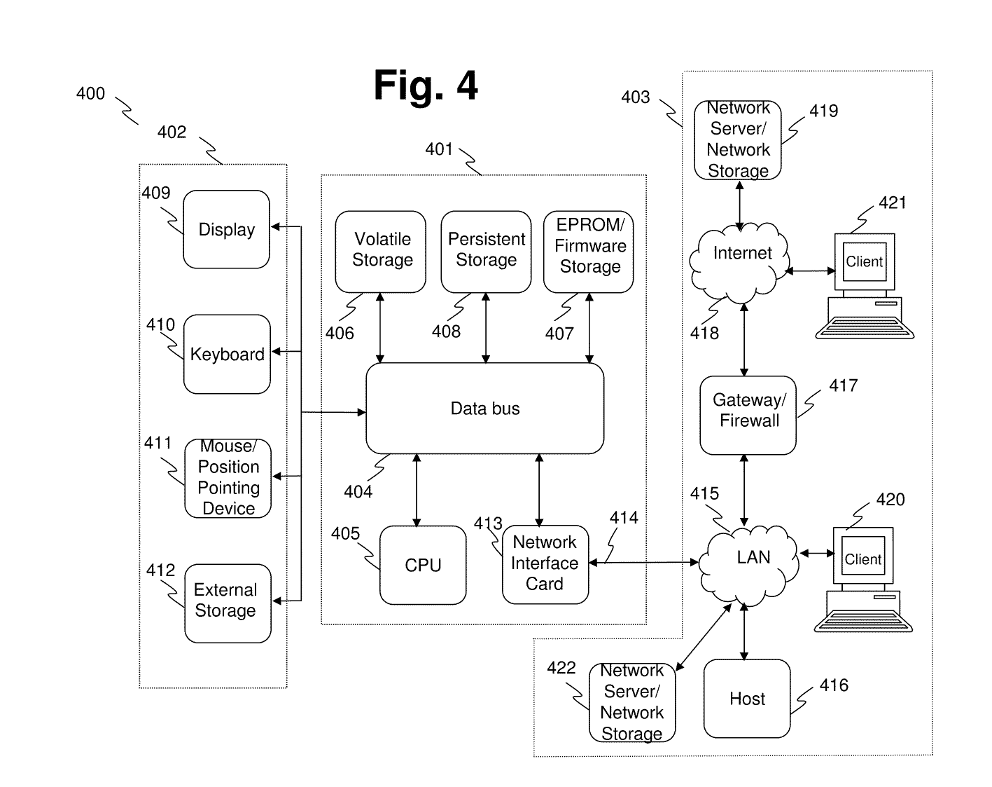

FIG. 4 illustrates an exemplary embodiment of a computer platform upon which the inventive system may be implemented.

FIG. 4 is a block diagram that illustrates an embodiment of a computer/server system 400 upon which an embodiment of the inventive methodology may be implemented. The system 400 includes a computer/server platform 401, peripheral devices 402 and network resources 403.

The computer platform 401 may include a data bus 405 or other communication mechanism for communicating information across and among various parts of the computer platform 401, and a processor 405 coupled with bus 401 for processing information and performing other computational and control tasks. Computer platform 401 also includes a volatile storage 406, such as a random access memory (RAM) or other dynamic storage device, coupled to bus 405 for storing various information as well as instructions to be executed by processor 405. The volatile storage 406 also may be used for storing temporary variables or other intermediate information during execution of instructions by processor 405. Computer platform 401 may further include a read only memory (ROM or EPROM) 407 or other static storage device coupled to bus 405 for storing static information and instructions for processor 405, such as basic input-output system (BIOS), as well as various system configuration parameters. A persistent storage device 408, such as a magnetic disk, optical disk, or solid-state flash memory device is provided and coupled to bus 401 for storing information and instructions.

Computer platform 401 may be coupled via bus 405 to a display 409, such as a cathode ray tube (CRT), plasma display, or a liquid crystal display (LCD), for displaying information to a system administrator or user of the computer platform 401. An input device 410, including alphanumeric and other keys, is coupled to bus 401 for communicating information and command selections to processor 405. Another type of user input device is cursor control device 411, such as a mouse, a trackball, or cursor direction keys for communicating direction information and command selections to processor 405 and for controlling cursor movement on display 409. This input device typically has two degrees of freedom in two axes, a first axis (e.g., x) and a second axis (e.g., y), that allows the device to specify positions in a plane.

An external storage device 412 may be coupled to the computer platform 401 via bus 405 to provide an extra or removable storage capacity for the computer platform 401. In an embodiment of the computer system 400, the external removable storage device 412 may be used to facilitate exchange of data with other computer systems.

The invention is related to the use of computer system 400 for implementing the techniques described herein. In an embodiment, the inventive system may reside on a machine such as computer platform 401. According to one embodiment of the invention, the techniques described herein are performed by computer system 400 in response to processor 405 executing one or more sequences of one or more instructions contained in the volatile memory 406. Such instructions may be read into volatile memory 406 from another computer-readable medium, such as persistent storage device 408. Execution of the sequences of instructions contained in the volatile memory 406 causes processor 405 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 405 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 408. Volatile media includes dynamic memory, such as volatile storage 406.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 405 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 405. The bus 405 carries the data to the volatile storage 406, from which processor 405 retrieves and executes the instructions. The instructions received by the volatile memory 406 may optionally be stored on persistent storage device 408 either before or after execution by processor 405. The instructions may also be downloaded into the computer platform 401 via Internet using a variety of network data communication protocols well known in the art.

The computer platform 401 also includes a communication interface, such as network interface card 413 coupled to the data bus 405. Communication interface 413 provides a two-way data communication coupling to a network link 415 that is coupled to a local network 415. For example, communication interface 413 may be an integrated services digital network (ISDN) card or a modem to provide a data communication connection to a corresponding type of telephone line. As another example, communication interface 413 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 413 sends and receives electrical, electromagnetic or optical signals that carry digital data streams representing various types of information.

Network link 413 typically provides data communication through one or more networks to other network resources. For example, network link 415 may provide a connection through local network 415 to a host computer 416, or a network storage/server 417. Additionally or alternatively, the network link 413 may connect through gateway/firewall 417 to the wide-area or global network 418, such as an Internet. Thus, the computer platform 401 can access network resources located anywhere on the Internet 418, such as a remote network storage/server 419. On the other hand, the computer platform 401 may also be accessed by clients located anywhere on the local area network 415 and/or the Internet 418. The network clients 420 and 421 may themselves be implemented based on the computer platform similar to the platform 401.

Local network 415 and the Internet 418 both use electrical, electromagnetic or optical signals that carry digital data streams. The signals through the various networks and the signals on network link 415 and through communication interface 413, which carry the digital data to and from computer platform 401, are exemplary forms of carrier waves transporting the information.

Computer platform 401 can send messages and receive data, including program code, through the variety of network(s) including Internet 418 and LAN 415, network link 415 and communication interface 413. In the Internet example, when the system 401 acts as a network server, it might transmit a requested code or data for an application program running on client(s) 420 and/or 421 through Internet 418, gateway/firewall 417, local area network 415 and communication interface 413. Similarly, it may receive code from other network resources.

The received code may be executed by processor 405 as it is received, and/or stored in persistent or volatile storage devices 408 and 406, respectively, or other non-volatile storage for later execution.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the system for dynamically and selectively displaying additional advertisements without changing the site design, location bar information or user navigation. It is intended that the specification and examples be considered as exemplary only, with a true scope and spirit of the invention being indicated by the following claims.

What is claimed is:

1. A computer-implemented method executed on a computer system comprising a central processing unit and a memory, the method comprising:
a. a user browser loading a web site document containing a reference to an advertisement and one or more site elements, the browser displaying a browser window;
b. the user browser issuing a request for an advertisement to an advertisement server and starting positioning one or more site elements within the browser window; and
c. the user browser receiving from the advertisement server in response to the issued request a script, the script containing a first and a second sets of computer instructions; the first set of computer instructions being executed after the user browser determines which site elements should be positioned inside the browser window, first set of instructions shifting positions of at least some of the site elements by a shift vector, thereby creating an additional space near the site content, and the second set of computer instructions being executed to display an advertisement inside the additional space.

2. The method of claim 1, wherein some of the site elements are shifted down.

3. The method of claim 1, wherein the advertisement is positioned within the browser window above the shifted site elements.

4. The method of claim 1, wherein the advertisement is positioned within the browser window above the shifted site elements.

5. The method of claim 1, wherein the script is operable to cause an interactive element to be displayed within or near the displayed advertisement, the interactive element instructing the script to reverse the shift and hide the displayed advertisement.

6. The method of claim 1, wherein the first set of computer instructions comprises instructions for detecting whether the some elements of the site can be successfully shifted and if the detection indicates that the site cannot be successfully shifted, no shift is performed.

7. The method of claim 1, wherein the first set of computer instructions comprises instructions for marking of already sifted elements and periodic checking of the document object for the new unmarked elements and either shifting these new unmarked elements or canceling display of the advertisement and removing the additional space if the new unmarked elements cannot be successfully shifted.

8. A computer-readable medium comprising computer instructions, which, when executed by one or more processors of a computer system, cause the one or more processors to perform a computer-implemented method comprising:
a. a user browser loading a web site document containing a reference to an advertisement and one or more site elements, the user browser displaying a browser window;
b. the user browser issuing a request for an advertisement to an advertisement server and starting positioning one or more site elements within the browser window; and
c. the user browser receiving from the advertisement server in response to the issued request a script, the script containing a first and a second sets of computer instructions; the first set of computer instructions being executed after the user browser determines which site elements should be positioned inside the browser window, first set of instructions shifting positions of at least some of the site elements by a shift vector, thereby creating an additional space near the site content, and the second set of computer instructions being executed to display an advertisement inside the additional space.

9. The computer-readable medium of claim 8, wherein some of the site elements are shifted down.

10. The computer-readable medium of claim 8, wherein the advertisement is positioned within the browser window above the shifted site elements.

11. The computer-readable medium of claim 8, wherein the advertisement is positioned within the browser window above the shifted site elements.

12. The computer-readable medium of claim 8, wherein the script is operable to cause an interactive element to be displayed within or near the displayed advertisement, the interactive element instructing the script to reverse the shift and hide the displayed advertisement.

13. The computer-readable medium of claim 8, wherein the first set of computer instructions comprises instructions for detecting whether the some elements of the site can be successfully shifted and if the detection indicates that the site cannot be successfully shifted, no shift is performed.

14. The computer-readable medium of claim 8, wherein the first set of computer instructions comprises instructions for marking of already sifted elements and periodic checking of the document object for the new unmarked elements and either shifting these new unmarked elements or canceling display of the advertisement and removing the additional space if the new unmarked elements cannot be successfully shifted.

15. A computerized system comprising:
a. a memory unit;
b. a central processing unit for executing a user browser for loading a web site document containing a reference to an advertisement and one or more site elements, the browser displaying a browser window, wherein the user browser issues a request for an advertisement to an advertisement server and starts positioning one or more site elements within the browser window; and
c. a network interface for receiving from the advertisement server in response to the issued request a script, the script containing a first and a second sets of computer instructions; the first set of computer instructions being executed after the user browser determines which site elements should be positioned inside the browser window, first set of instructions shifting positions of at least some of the site elements by a shift vector, thereby creating an additional space near the site content, and the second set of computer instructions being executed to display an advertisement inside the additional space.

16. The computer-readable medium of claim 15, wherein the advertisement is positioned within the browser window above the shifted site elements.

17. The computer-readable medium of claim 15, wherein the advertisement is positioned within the browser window above the shifted site elements.

18. The computer-readable medium of claim 15, wherein the script is operable to cause an interactive element to be displayed within or near the displayed advertisement, the interactive element instructing the script to reverse the shift and hide the displayed advertisement.

19. The computer-readable medium of claim 15, wherein the first set of computer instructions comprises instructions for detecting whether the some elements of the site can be successfully shifted and if the detection indicates that the site cannot be successfully shifted, no shift is performed.

20. The computer-readable medium of claim 15, wherein the first set of computer instructions comprises instructions for marking of already sifted elements and periodic checking of the document object for the new unmarked elements and either shifting these new unmarked elements or canceling display of the advertisement and removing the additional space if the new unmarked elements cannot be successfully shifted.
